(19) United States
(12) Patent Application Publication
(10) Pub. No.: US 2016/0278406 A1
(43) Pub. Date: Sep. 29, 2016

(54) PROCESS FOR REDUCTING OFF-FLAVOR PRODUCTION OF GLUCAN

(71) Applicants: Matt STENZEL, Northfield, MN (US); John BLOCHER, Vadnais Heights, MN (US); Donald COX, Maple Grove, MN (US); Elizabeth ST. GERMAIN, Eagan, MN (US); Biothera, Inc., Eagan, MN (US)

(72) Inventors: Matt Stenzel, Northfield, MN (US); John Blocher, Vadnais Heights, MN (US); Donald Cox, Maple Grove, MN (US); Elizabeth St. Germain, Eagan, MN (US)

(21) Appl. No.: 15/034,251

(22) PCT Filed: Nov. 4, 2014
(86) PCT No.: PCT/US2014/063881

§ 371 Date: May 4, 2016

Related U.S. Application Data
(60) Provisional application No. 61/900,099, filed on Nov. 5, 2013.

(51) Int. Cl. C07H 1/00; C08B 37/00

(52) U.S. Cl. CPC A23L 1/0155; C08B 37/0024; A23V 2002/00

(57) ABSTRACT

The present invention relates to a process for decreasing off-flavors of dried beta glucan. The pH of the beta glucan is lowered prior to drying the beta glucan in order to reduce Maillard reactions which produce the off-flavors.

This application claims priority to U.S. Provisional Patent Application Ser. No. 61/900,099, filed Nov. 5, 2013, which is incorporated herein by reference.

### BACKGROUND

The present invention relates to the field of glucan production. The level of off-flavor present in typical spray-dried yeast beta glucan range from mild yeasty flavor with a slightly bitter after taste to chemical, burnt, bitter and plastic. These flavors are consistent with the flavors developed during Maillard browning. Spray drying conditions are know to affect browning and undesirable flavor development during the spray drying of many food products (nonfat dried milk is key example). Manipulation of drying conditions to minimize heating of the particles in the dryer is most often used to prevent browning of heat sensitive products. Encapsulation of heat sensitive components is also used to reduce product damage during drying.

### SUMMARY OF THE INVENTION

Acidification of the beta glucan slurry significantly reduces off-flavor production by inhibiting Maillard reactions and permits drying under conditions that would otherwise result in objectionable levels of off-flavor in the final beta glucan powder. The addition of acid to reduce a glucan slurry pH to 3.0-4.0 prior to drying significantly improved the flavor of the spray dried product.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGURES

FIG. 1 shows samples of dried beta glucan.

### DETAILED DESCRIPTION OF ILLUSTRATIVE EMBODIMENTS

The Maillard reaction is not a single reaction, but a complex series of reactions between amino acids and reducing sugars, usually at increased temperatures. In the process, hundreds of different flavor compounds can be created. These compounds in turn break down to form additional new flavor compounds. Each type of food has a very distinctive set of flavor compounds that are formed during the Maillard reaction. Maillard reactions are important in baking, frying or otherwise heating of nearly all foods. For example, they are (partly) responsible for the flavor of bread, cookies, cakes, meat, beer, chocolate, popcorn and cooked rice. Although studied for nearly one century, Maillard reactions are so complex that many of the reactions and pathways are still unknown. Many different factors play a role in the Maillard formation and thus in the final color and aroma. For example, pH (acidity), type of amino acid and sugar, temperature, time, presence of oxygen, water, water activity (a_{w}) and other food components present in the food matrix are all important in the outcome of the Maillard reaction.

The first step of the Maillard reaction is the reaction of a reducing sugar, such as glucose, with an amino acid, resulting in a reaction product called an Amadori compound.

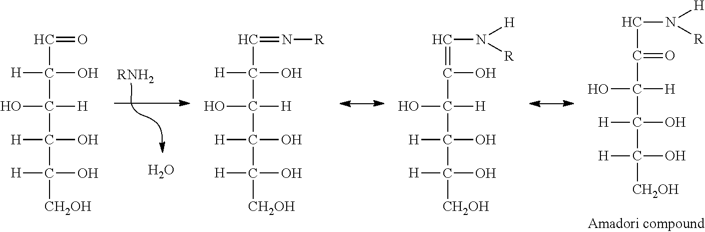

Amadori compounds easily isomerise into three different structures that can react differently in the following steps. In yeast derived beta glucan, the only sugar present is glucose with the reaction potentially occurring at the end of the main chain and at the end sugar unit in each branched chain.

The next steps in the reaction will differ, depending on the specific isomer of the Amadori compound formed in the product and the conditions under which the reaction is occurring. The amino acid may be removed and this results in reactive compounds that are finally degraded to the important flavor components furfural and hydroxymethyl furfural (HMF). The other reaction is the so-called Amadori-rearrangement, which is the starting point of the main browning reactions listed below.

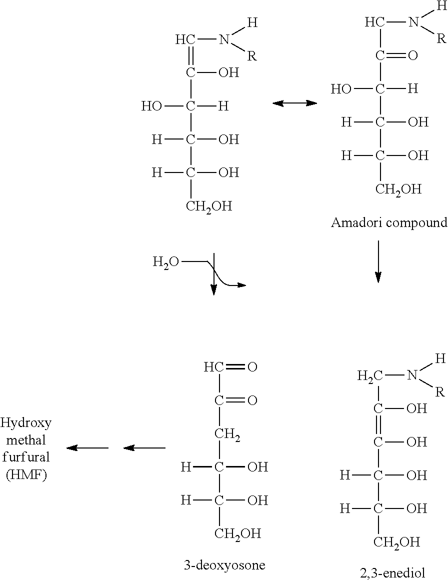

Hydroxymethylfurfural (HMF) is one of the characteristic flavor compounds of the Maillard reaction when the reaction involves glucose (as is the case with yeast derived beta glucan) and is described as tasting burnt, bitter and astringent.

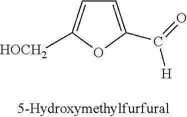

After the Amadori-rearrangement three different main pathways can be distinguished:
Dehydration reactions,
Fission, when the short chain hydrolytic products are produced, for example diacetyl and pyruvaldehyde,
“Strecker degradations” with amino acids or they can be condensated to aldols. These three main pathways finally result in very complex mixtures, including flavor compounds and brown high molecular weight pigments.

Participation of glucans and other polysaccharides (starch) in Maillard reactions has been reported. Maillard reactions require either a free aldehyde or ketone group to react with the amino group. In a glucopolysaccharide like an unbranched maltodextrin, this only occurs at one end of each polymer. With a branched glucopolysaccharide like yeast derived beta glucan, there are potential reaction sites at the end of the main polymer chain and at the end of each side chain on the polymer. Since the 1,6 branch points in yeast derived beta glucan are approximately 4-6% of the total linkages, this would indicate that 4-6% of the total glucose units in each polymer would be available to participate in Maillard reactions. Because of this small amount of available glucose units, this was previously not seen as a possible cause of off-flavoring.

Protein content and amino acid type will influence both the rate and types of end products produced by Maillard browning. Based on the nitrogen content, dispersible yeast derived beta glucan is calculated to typically contain 1.5-2.5% protein. This protein level is lower than in many of the systems studied for Maillard reactions (NFDM, whey powder and vegetable powders), but should still be more than sufficient to support browning via the Maillard pathway.

Recent evidence suggests that some or all of the nitrogen in dispersible yeast derived beta glucan is found in chitosan, which is a polymeric form of glucosamine.

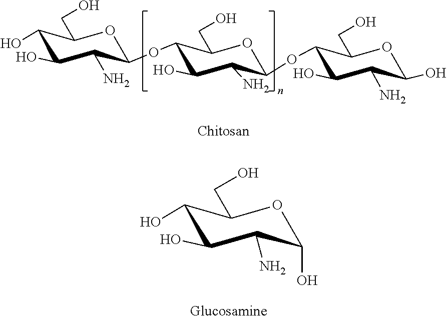

Chitosan polymers have been found to be susceptible to Maillard browning under low moisture conditions at temperature of 60° C., which is very often encountered during the spray-drying process. Glucosamine is essentially an Amadori compound, which is the first type of compound formed by the reaction of glucose and an amino acid during Maillard browning. Chitosan may either function as the donor of an amine group in a browning reaction with yeast derived beta glucan, or it may simply degrade by itself along the same browning pathways without reacting with yeast derived beta glucan. Either way the resulting production of flavor compounds can occur. Browning reactions have been reported as a primary source of breakdown of chitin polymers during temperature and moisture conditions found during spray-drying, which are similar to those that allow Maillard browning in foods containing reducing carbohydrates and proteins.

There are several reasons that Maillard reactions were previously not considered the major cause of the off-flavoring in beta glucan. First, most products with Maillard reactions involve mono and disaccharides reacting with proteins. Beta glucan is low in both. Second,

Malliard reactions have not involved chitosan as the nitrogen source, which is what seems to be involved in browning with beta glucan, not protein. There is nothing in the literature that describes Maillard reactions between a beta glucan and amino groups from chitosan. Third, browning of long chain carbohydrates like starches or beta glucans are typically not an issue due to limited number of carboxyl groups available for reaction. Fourth, browning reactions are most studied in liquid systems not at low water activity that occurs during or just after spray drying.

Maillard browning has been reported in skim milk and whey powders at moistures of 3.5-5%. Rates are temperature dependent with a Q₁₀ of 2-4 indicating that as the storage temperature goes up 10° C., reaction rates increase by a factor of 2-4 fold. Due to the well-established relationship between temperature and the rate of Maillard browning reactions, manipulation of drying conditions to minimize the total heating of the particles in the dryer is the primary method that has been used to reduce browning of heat sensitive products.

A spray dryer takes a liquid solution or suspension and rapidly evaporates the water leaving behind a dry solid particle. The liquid input stream is atomized into a hot air stream and the water is vaporized. Solid particles form as moisture quickly leaves the droplets. A nozzle or spinning disc are usually used to make the droplets as small as possible, maximizing heat transfer and the rate of water vaporization. Droplet sizes can range from 20 to 180 μm depending on the nozzle size or rotational speed of the spinning disc.

Dryer design as well as optimization of drying conditions have focused on maximizing production rates while limiting off flavor and color production due to heating to levels that are acceptable from a product quality standpoint. The key variables typically manipulated in establishing spray-drying conditions include: dryer feed stock (solids content, temperature, pressure at nozzle), spray dryer design (size and geometry of the drying chamber, nozzle number and size) and dryer conditions (temperature of inlet and outlet air, air flow in dryer).

Manipulation of the product being spray dried to reduce browning has been mainly limited to isolating the maillard reactants from one another. Proposed methods have included: 1) introducing non-reactive materials to reduce the opportunity of the reducing sugars and amino groups to interact and 2) Encapsulation of heat sensitive components to reduce contact between reactants during drying.

Maillard reactions are known to be pH dependent. Alkaline pH will enhance the reaction resulting in the production of more color and flavor, while acidic conditions inhibit the reactions. Use of alkaline pH to enhance the production of Maillard reaction end products has been studied extensively and is used by the flavor industry to produce “reaction” flavors. These flavors are used to enhance the cooked flavor in many types of food products. While it is known that Maillard reactions are slower under acidic conditions, this has not been utilized commercially to control browning during spray drying. As noted above, efforts to reduce Maillard browning in spray drying have focused on reducing the amount of heating that occurs during spray drying as the primary method, or to a lesser extent by separating the reactants.

### Example 1

To determine the effects of beta glucan slurry pH and spray dryer temperatures on the final (dried) color and flavor of spray dried yeast beta glucan, a series of experiments were performed. Yeast beta glucan slurry (approximately 5% solids by weight) extracted from yeast cell wall by caustic and acid treatment was used as the starting material for the experiments. The pH of the slurry was adjusted using 50% w/w sodium hydroxide and 18 M sulfuric acid. Other acids and bases may be used to adjust the pH of the slurry.

An initial screening test examined the effects of a broad range of pH from a low of 3.0 to a high of 10.3 in combination with temperature ranges of 175° C.-190° C. for the inlet air and 75° C.-90° C. for the outlet air. The lower temperature limits of 175° C./75° C. (inlet/outlet) were due to product starting to stick on the spray dryer sidewall.

To analyze for flavor, 200 mg of sample was added to 200 ml water (concentration of 1 mg/ml) and stirred until the powder was dispersed. The samples were tasted and evaluated by multiple individuals familiar with the product flavor profile for the presence of astringent, bitter, or burnt flavors, which are indicative of Maillard reaction flavors. Table 1 below shows the conditions for the initial screening test and the results of organoleptic analysis for flavor.

TABLE 1

| | | Inlet Air | Outlet Air | |
|---|---|---|---|---|
| Sample | pH | Temp | Temp | Flavor |
| 1 | 3.0 | 190° C. | 90° C. | Low flavor, slight astringent, |
| | | | | “cardboard” |
| 2 | 3.0 | 180° C. | 80° C. | Low flavor, slight astringent, |
| | | | | “cardboard” |
| 3 | 3.0 | 175° C. | 75° C. | Low flavor, slight astringent, |
| | | | | “cardboard” |
| 4 | 7.0 | 175° C. | 75° C. | Moderate astringent, chemical |
| 5 | 7.0 | 180° C. | 80° C. | Moderate astringent, chemical |
| 6 | 7.0 | 190° C. | 90° C. | Moderate astringent, chemical |
| 7 | 10.3 | 180° C. | 80° C. | High, astringent, chemical |
| 8 | 10.3 | 190° C. | 90° C. | High, astringent, chemical |
| 9 | 10.3 | 175° C. | 75° C. | High, astringent, chemical |

These initial tests indicated that pH had a greater effect on the presence or absence of Maillard reaction flavor with pH 3.0 samples having lower levels of Maillard reaction flavors and pH 10.3 samples having higher levels of Maillard reaction flavors. Spray dryer temperatures had a much smaller impact on the overall flavor of the samples.

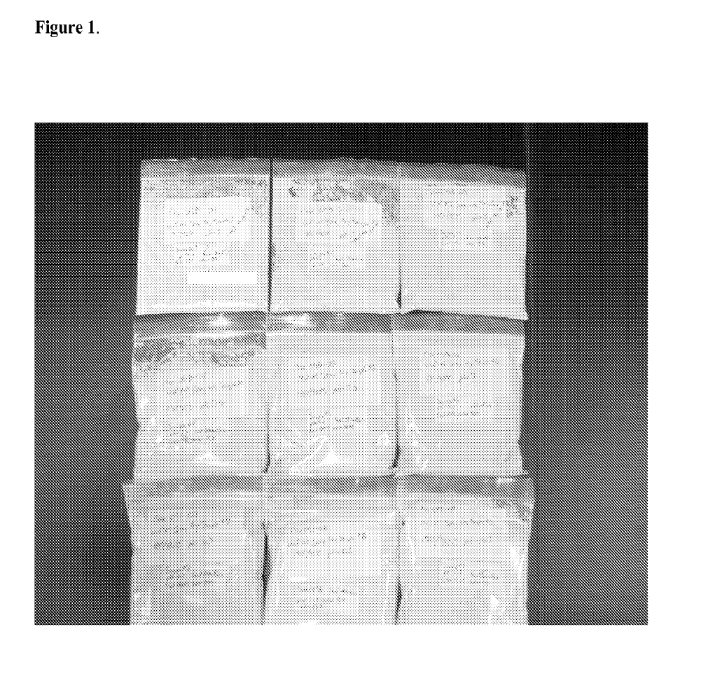

Samples were collected and analyzed for color as well. The color variation between all nine samples was minimal as shown in FIG. 1.

### Example 2

Based on the results of Example 1, a second set of experiments was performed to optimize the pH range for minimal Maillard reaction flavors. Once again, the starting material was a 5% solids slurry of yeast beta glucan after base and acid treatment. The targeted pH range for this series of tests was from approximately 3.0 to 5.0. The pH of the samples was adjusted using 50% w/w sodium hydroxide and 18 M sulfuric acid. Because dryer temperatures had minimal impact on flavor, the dryer was kept at a constant temperature of 190° C. as this results in the fastest operating rates as well. Table 2 below shows the conditions for this second set of experiments and the results of organoleptic analysis.

TABLE 2

| | | Inlet Air | Outlet Air | |
|---|---|---|---|---|
| Sample | pH | Temp | Temp | Flavor |
| 1 | 2.83 | 190° C. | 90° C. | Low flavor, slight astringent |
| 2 | 3.48 | 190° C. | 90° C. | Low flavor, slight astringent |
| 3 | 4.94 | 190° C. | 90° C. | Low/Moderate, slight astringent |
| 4 | 3.76 | 190° C. | 90° C. | Low/Moderate, slight astringent |
| 5 | 3.98 | 190° C. | 90° C. | Low/Moderate, slight astringent |
| 6 | 4.50 | 190° C. | 90° C. | Low/Moderate, slight astringent |

The Maillard reaction and accompanying flavors are impacted by adjusting the pH of the liquid slurry being fed to the atomizing spray dryers. Specifically, for beta glucan slurries, the Maillard reaction has a minimum reaction rate at a pH range of about 2.5 to 4.0. Use of other acids than used above may change the pH range slightly but would still be in the acidic range (pH<5). A forced ranking of the low pH sample set (pH 2.83-4.50) indicated that there were only minor differences between all of the samples and all samples had relatively low flavor compared to currently available commercial product.

The present invention provides several advantages. As discussed above, lowering the pH of the beta glucan slurry reduces off-flavor formation during drying. Because of the reduction of off-flavors, yeast beta glucan can be formulated into flavor sensitive food and beverage preparations without having to use more expensive options such as solubilized yeast beta glucans or flavor masking agents. With the present invention, users also have the ability to dry yeast beta glucan under conditions that expose the glucan to higher temperatures for longer times with less production of off flavors and colors. This would permit the glucan to be dried using equipment or conditions that reduce production cost. Examples would include: a) use of less expensive dryer designs such as box spray driers or b) drying conditions that provide higher production rates but expose the glucan to higher temperatures (i.e. high feed rate combined with higher heat drying conditions). Another benefit is that production of beta glucans with reduced off-flavor can be carried out with minimal impact on production costs, because the only additional step is the addition of acid to lower the pH of the beta glucan slurry. The cost of the acid and the time to add it to the slurry are both minimal. And lastly, the stability of dried yeast beta glucan and products containing yeast beta glucan is enhanced due to lower amounts of Maillard by-products.

The initial Maillard reaction products formed during spray drying of the yeast beta glucan may have autocatalytic properties that increase the rate of further off flavor development during the of heat treatment and storage of a final product containing the beta glucan.

### REFERENCES

1. Cremer, D. R. and K. Eichner (2000). “The influence of the pH value on the formation of Strecker aldehydes in low moisture model systems and in plant powders.” European Food Research & Technology 211(4): 247-251.
2. Bensabat, L., Frampton, V., Allen, L. Hill R. 1958 “Effect of processing on the ε-amino groups of lysine in peanut proteins.” J. Agr. Food Chem., 6:778
3. Fors, S. (1983). “Sensory properties of volatile Maillard reaction products and related compounds Non-enzymatic browning reactions, heat-treated foods, chemical structures.” ACS Symposium series American Chemical Society 215: 185-286.
4. Kroh, L. W., W. Jalyschko, et al. (1996). “Non-volatile reaction products by heat-induced degradation of alpha-glucans. Part I. Analysis of oligomeric maltodextrins and anhydrosugars.” Starch 48(11-12): 426-433.
5. Kroh, L. W. and A. Schulz (2001). “News on the Maillard reaction of oligomeric carbohydrates: A survey.” Nahrung 45(3): 160-163.
6. Pereyra-Gonzales, A. S., G. B. Naranjo, et al. (2010). “Maillard reaction kinetics in milk powder: effect of water activity at mild temperatures.” International Dairy Journal 20(1): 40-45.
7. Sithole, R., M. R. McDaniel, et al. (1636). “Rate of Maillard browning in sweet whey powder.” Journal of Dairy Science 88(5): 1636-1645.
8. Zeng, L., C. Qin, et al. “Browning of chitooligomers and their optimum preservation.” Carbohydrate polymers 67(4): 551-558.

The complete disclosure of all patents, patent applications, and publications, and electronically available material cited herein are incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

1. A process for decreasing off-flavors in dried beta glucan comprising:
acidifying a beta glucan slurry; and
spray drying the beta glucan slurry.

2. The process of claim 1 wherein the beta glucan slurry has a pH less than about 5 prior to spray drying.

3. The process of claim 1 wherein the beta glucan slurry is acidified with sulfuric acid.

4. A process for decreasing Malliard reactions during production of dried beta glucan comprising:
adding acid to a beta glucan slurry;
drying the beta glucan with heat.

5. The process of claim 4 wherein acid is added until the beta glucan slurry has a pH less than about 5.

6. The process of claim 5 wherein drying further comprises heating to a temperature between about 175° C. to about 190° C.

7. The process of claim 5 wherein the acid is sulphuric acid.

8. The process of claim 1 wherein the beta glucan slurry is derived from yeast.

9. A dried beta glucan made by a process comprising:
acidifying a beta glucan slurry; and
spray drying the beta glucan slurry.

10. The dried beta glucan of claim 10 wherein the dried beta glucan is derived from yeast.

11. The dried beta glucan of claim 10 wherein the beta glucan is acidified to a pH between 2.83 and 4.50.

12. The dried beta glucan of claim 10 wherein the beta glucan slurry is spray dried at a temperature between about 175° C. to about 190° C.

13. The process of claim 4 wherein the beta glucan slurry is derived from yeast.
